(19) United States
(12) Patent Application Publication
(10) Pub. No.: US 2012/0017100 A1
(43) Pub. Date: Jan. 19, 2012

(54) Power System Optimization and Verification for Embedded System Design

(76) Inventors: Emmanuel Petit, Chevreuse (FR); Mohamed Shalan, Cairo (EG); Irfan Ahmad, Lahore (PK)

(21) Appl. No.: 13/035,882

(22) Filed: Feb. 25, 2011

Related U.S. Application Data
(60) Provisional application No. 61/307,865, filed on Feb. 25, 2010.

(51) Int. Cl. G06F 1/26

(52) U.S. Cl. 713/300

(57) ABSTRACT

Tools and methods for developing and verifying a power management solution for an embedded system are provided. The firmware for an embedded system is partitioned into layers, including a control layer. The control layer implements a high-level power management behavior for the embedded system. A power profile development tool is also provided. The tool includes modules for describing the power functioning of the hardware of the embedded system, defining the desired power management behavior of the embedded system, and configuring the control layer within the firmware for the embedded system to implement the desired power management behavior. Furthermore, modules that interface with the embedded system and receive power system events and power status information and simulating the expected power management behavior based in part upon the received power event data and comparing the simulated behavior to the received power status behavior may also be provided.

### RELATED APPLICATIONS

This application claims priority under 35 U.S.C. §119(e) to U.S. Provisional Patent Application No. 61/307,865 entitled “Optimization and Verification for Power System Design” filed on Feb. 25, 2010, and naming Emmanuel Petit et al. as inventors, which application is incorporated entirely herein by reference.

### FIELD OF THE INVENTION

The invention relates to the design of embedded electronic systems. More specifically, various implementations of the invention are applicable to optimizing and verifying the power requirements of an embedded system.

### BACKGROUND OF THE INVENTION

In general, an embedded system may be described as a special purpose computing system designed to perform one or a few dedicated functions. Embedded systems are commonly used in consumer devices like personal digital assistants, mobile phones, videogame consoles, microwaves, washing machines, alarm systems, and digital cameras. In addition to the consumer space, embedded systems are used in nearly every industry, from telecommunications to manufacturing, and from transportation to medical devices. In fact, embedded systems are so commonly in use today that it is not feasible to exhaustively list specific examples.

The term “embedded system” does not have a precise definition, and determining what is and is not an embedded system can be difficult. For example, a general purpose computer, such as a laptop, is not typically characterized as an embedded system. However, a laptop is usually composed of a multitude of subsystems such as the hard disk drive, the motherboard, the optical drive, the video processing unit, and various communication devices. Many of the individual subsystems comprising the laptop may themselves be embedded systems.

The complexity of embedded systems can vary from, for example, systems with a single microcontroller chip and a light emitting diode to systems with multiple microprocessor units and various peripheral communication interfaces and mechanical parts. Manufacturers of modern microprocessors are increasingly adding components and peripheral modules to their microprocessors, creating what may be thought of as embedded processors. This type of embedded system is often referred to as a system on a chip (SoC). A simple example of a system on chip is an application-specific integrated circuit (ASIC) packaged with a universal serial bus (USB) port. Additionally, embedded systems range from those having no user interface at all to those with full user interfaces similar to a desktop operating system.

There are many advantages to using embedded systems. For example, an embedded system typically is designed to do some specific task, as opposed to being a general purpose computer with a wide range of features for performing many different tasks. As a result, design engineers can optimize the embedded system for the desired task, which assists in reducing the size and cost of the device as well as increasing its reliability and performance. Furthermore, functionalities can be designed into an embedded system that would not be feasible using hardware alone.

By using software to accomplish some of the functionality that would have been accomplished in hardware, designers may specify and define certain functionality later in the design cycle than was previously possible. An additional advantage is that embedded system designs can often be reconfigured for different functionality with less engineering overhead than a design embodied entirely by hardware. As a result, design reuse can be increased, resulting in a reduced time to market.

The software written for embedded systems is generally referred to as “firmware.” Firmware is often stored on read only memory (“ROM”) based storage devices. For example, flash-based read only memory or electronically erasable read only memory (“EEPROM”) devices are often used to store firmware. The firmware controls the various features, functioning, and interfaces of the embedded system. Thus, a digital video disk player will have firmware that processes the appropriate response to an input, such as the user pressing the “power” button or the “play” button. Additionally, the firmware in this example would control the storage mechanism, the digital processing circuitry used to decode and output onto the appropriate ports the video and audio signals stored on the video storage medium, as well as the user interface allowing the user to configure settings of the digital video disk player.

Modern embedded systems often allow the user to execute an additional application, often referred to as an “app”, on the device. For example, an app may be loaded into a memory location accessible by the embedded systems firmware such that the app may be executed by the embedded systems firmware. The various instructions that the embedded system executes, such as, for example, the firmware or apps, are often referred to herein as “computer executable applications”. However, they may also be referred to herein as firmware, software, applications, programs, or apps.

As stated, embedded systems can include a number of various processing and peripheral components. The power consumption of an embedded system is often dictated by what states the various processing and peripheral components are in. More particularly, a component may be in any number of varying power states from drawing 0% power to drawing 100% power. As the number of components within an embedded system increases and as the number of power states for each component increases, designing a comprehensive power management solution for the embedded system becomes exponentially more difficult.

### BRIEF SUMMARY OF THE INVENTION

Various implementations of the present invention provide methods and apparatuses for designing an embedded system power model.

With various implementation of the invention, the firmware for an embedded system is partitioned into layers, including a control layer. The control layer includes modules for controlling the high-level power management behavior or the embedded system. A power profile development tool is also provided. The tool includes modules for describing the power functioning of the hardware of the embedded system. Modules for defining the desired power management behavior of the embedded system, and modules for configuring the control layer within the firmware for the embedded system to implement the desired power management behavior.

With further implementations of the invention, the power profile development tool may include verification modules that can interface with the embedded system and receive power system events and power status information. The tool also may include modules for simulating the expected power management behavior based in part upon the received power event data and comparing the simulated behavior to the received power status behavior.

In some implementations, methods for developing a power management solution for an embedded system are provided. The method includes operations for defining power states for the embedded system hardware, generating a representation of the desired power management behavior using the defined power states, partitioning the firmware of the embedded system into layers including a control layer, and configuring the control layer to implement the desired power management behavior.

In further implementations, methods for verifying an embedded systems power management behavior are provided. The method includes operations for receiving power event and power status information for the embedded system, simulating the expected power management behavior using the received power event data, and comparing the simulated power behavior to the received power status information.

These and other features and aspects of the invention will be apparent upon consideration of the following detailed description of illustrative embodiments.

### BRIEF DESCRIPTION OF THE DRAWINGS

The present invention will be described by way of illustrative embodiments shown in the accompanying drawings in which like references denote similar elements, and in which:

FIG. 1 shows an illustrative embedded system;

FIG. 2 shows an illustrates operating environment;

FIG. 3 illustrates an power profile development system;

FIG. 4 shows a portion of the power profile development system of FIG. 3 in greater detail;

FIG. 5 shows an illustrative state transition diagram;

FIG. 6 shows an illustrative state transition diagram;

FIG. 7 shows an illustrative state transition diagram;

FIG. 8 shows a portion of the power profile development system of FIG. 3 in greater detail;

FIG. 9 shows an illustrative state transition diagram;

FIG. 10 shows a portion of the power profile development system of FIG. 3 in greater detail;

FIG. 11 illustrates a method of developing a power profile for an embedded system; and

FIG. 12 illustrates a method of verifying a power profile for an embedded system.

### DETAILED DESCRIPTION OF ILLUSTRATIVE IMPLEMENTATIONS

The operations of the disclosed implementations may be described herein in a particular sequential order. However, it should be understood that this manner of description encompasses rearrangements, unless a particular ordering is required by specific language set forth below. For example, operations described sequentially may in some cases be rearranged or performed concurrently. Moreover, for the sake of simplicity, the illustrated flow charts and block diagrams typically do not show the various ways in which particular methods can be used in conjunction with other methods.

It should also be noted that the detailed description sometimes uses terms like “generate” to describe the disclosed implementations. Such terms are often high-level abstractions of the actual operations that are performed. The actual operations that correspond to these terms will often vary depending on the particular implementation.

As stated above, various implementations of the invention provide methods and apparatuses for optimizing and verifying power consumption profiles for an embedded system. As such, brief overviews of an embedded system, as well as an illustrative operating environment suitable for practicing the invention are described below.

### Illustrative Embedded System

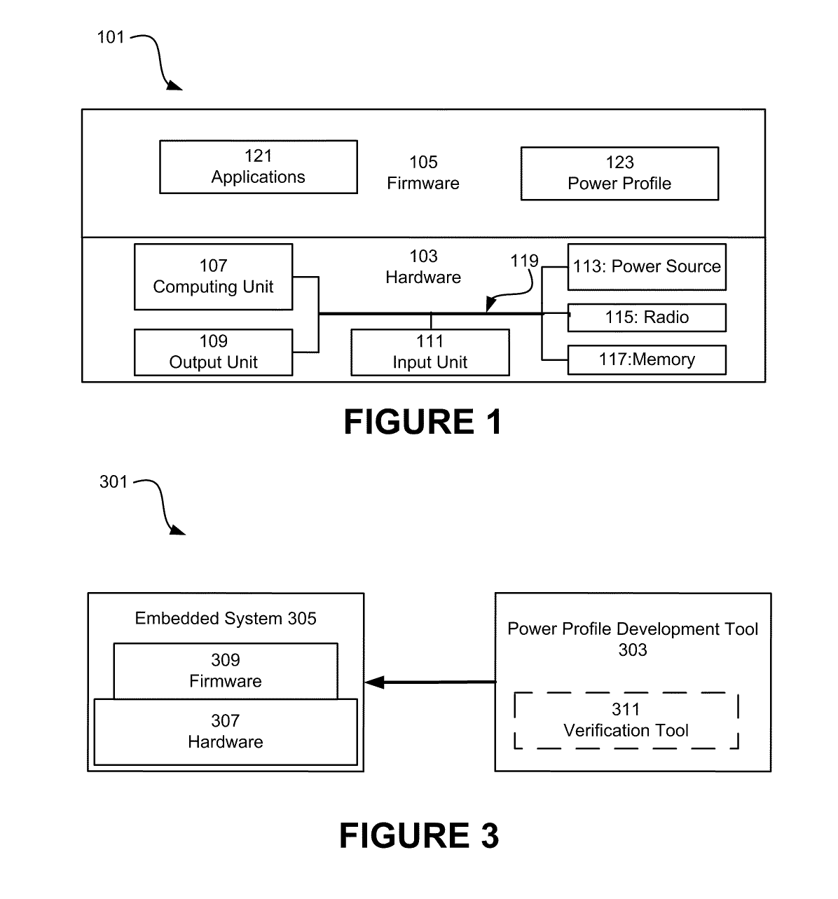

As detailed above, an embedded system is a combination of hardware and software, often designed for a particular task. FIG. 1 illustrates an embedded system 101. As can be seen from this figure, the embedded system 101 includes a hardware component 103 and firmware 105. As illustrated, the hardware component 103 includes a computing unit 107, an output unit 109, an input unit 111, a power source 113, a radio 115, and a memory 117. The hardware components are interconnected with a bus 119. Those of skill in the art will appreciate that not all embedded systems include the features illustrated in FIG. 1. Furthermore, additional features, not illustrated in FIG. 1, may be present in an embedded system.

The firmware 105 typically includes the drivers necessary for the functioning of the hardware 103 as well as various manufacturer provided applications and user interface software. As those of skill in the art will appreciate, applications 121 can be executed on the embedded system 101 to add or complement the functionality provided by the hardware 103 and the firmware 105.

As stated previously, embedded systems, such as, for example, the embedded system 101, can operate in a number of different power modes. More particularly, as those of skill in the art will appreciate, the various components of the hardware are often capable of operating in a number of different “power states.” For example, a typical computing unit 107 can operate at a number of different frequencies and voltage settings. These various settings are often referred to as operating points. Furthermore, various other components, such as, the output unit 109 may have a number of different power states. For example, if the output unit 109 were a liquid crystal display (LCD) device, then the unit 109 would typically be able to operate in a number of different brightness settings, in addition to having an “off” state as well as a “100%” on state.

Often, the firmware 105 includes a power profile 123 that controls the power supplied to the various components of the hardware 103. More particularly, the power profile 123 determines what power state each component should be in during operation of the device. As will be appreciated by those of skill in the art, during the operation of an embedded system it may be desirable to have certain components operate at a particular power state depending upon the particular use of the embedded system at that time. Furthermore, during alternate uses of the embedded system it is often desirable that those particular components operate at different power states. As can be appreciated, as the number of components within an embedded system increases, the number of potential power state combinations for the entire embedded system increases, often exponentially. This increase in potential power states, in turn, increases the difficulty of developing a comprehensive power profile for the embedded system.

### Illustrative Operating Environment

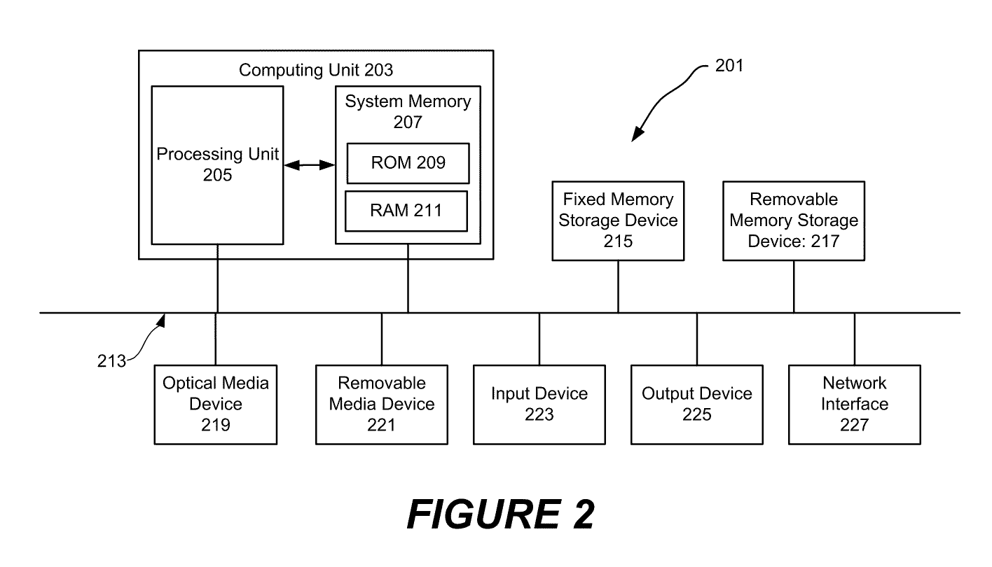

As the techniques of the present invention may be implemented using software instructions, the components and operation of a computer system on which various implementations of the invention may be employed is described. Accordingly, FIG. 2 shows an illustrative computing device 201. As seen in this figure, the computing device 201 includes a computing unit 203 having a processing unit 205 and a system memory 207. The processing unit 205 may be any type of programmable electronic device for executing software instructions, but will conventionally be a microprocessor. The system memory 207 may include both a read-only memory (“ROM”) 209 and a random access memory (“RAM”) 211. As will be appreciated by those of ordinary skill in the art, both the ROM 209 and the RAM 211 may store software instructions for execution by the processing unit 205.

The processing unit 205 and the system memory 207 are connected, either directly or indirectly, through a bus 213 or alternate communication structure, to one or more peripheral devices. For example, the processing unit 205 or the system memory 207 may be directly or indirectly connected to one or more additional devices, such as; a fixed memory storage device 215, for example, a magnetic disk drive; a removable memory storage device 217, for example, a removable solid state disk drive; an optical media device 219, for example, a digital video disk drive; or a removable media device 221, for example, a removable floppy drive. The processing unit 105 and the system memory 207 also may be directly or indirectly connected to one or more input devices 223 and one or more output devices 225. The input devices 223 may include, for example, a keyboard, a pointing device (such as a mouse, touchpad, stylus, trackball, or joystick), a scanner, a camera, and a microphone. The output devices 225 may include, for example, a monitor display, a printer and speakers. With various examples of the computing device 201, one or more of the peripheral devices 215-225 may be internally housed with the computing unit 203. Alternately, one or more of the peripheral devices 215-225 may be external to the housing for the computing unit 203 and connected to the bus 213 through, for example, a Universal Serial Bus (“USB”) connection.

With some implementations, the computing unit 203 may be directly or indirectly connected to one or more network interfaces 227 for communicating with other devices making up a network. The network interface 227 translates data and control signals from the computing unit 203 into network messages according to one or more communication protocols, such as the transmission control protocol (“TCP”) and the Internet protocol (“IP”). Also, the interface 227 may employ any suitable connection agent (or combination of agents) for connecting to a network, including, for example, a wireless transceiver, a modem, or an Ethernet connection.

It should be appreciated that the computing device 201 is shown here for illustrative purposes only, and it is not intended to be limiting. Various embodiments of the invention may be implemented using one or more computers that include the components of the computing device 201 illustrated in FIG. 2, which include only a subset of the components illustrated in FIG. 2, or which include an alternate combination of components, including components that are not shown in FIG. 2. For example, various embodiments of the invention may be implemented using a multi-processor computer, a plurality of single and/or multiprocessor computers arranged into a network, or some combination of both.

### Embedded System Power Optimization and Verification

As indicated above, various implementations of the present invention are directed towards developing, optimizing, and verifying a power profile for an embedded system. FIG. 3 illustrates a power profile development system 301, which may be provided by various implementations of the present invention. As can be seen from this figure, the system 301 includes a power profile development tool 303 and an embedded system 305. As detailed above, an embedded system, such as, for example, the embedded system 305 includes both hardware 307 and firmware 309. Various implementations of the present invention provide a development environment for optimizing and verifying a power profile, which may later be incorporated into an embedded systems firmware (e.g. the firmware 309). As those of skill in the art will appreciate, it is often desirable to develop the firmware (including the power profile) for an embedded system before an actual prototype of the embedded system is available. As such, in some implementations, the embedded system 305 shown here may be a simulation of the embedded system 305. More specifically, the functionality of the hardware 307 may be simulated by a computing device in such a manner that the firmware 309 can be executed by the computing device. Alternatively, a prototype of the embedded system 305 may be provided in various implementations. In still other implementations, the firmware 309 may be developed independently from the hardware 307 and not tested or executed upon the hardware 307 at this stage of development.

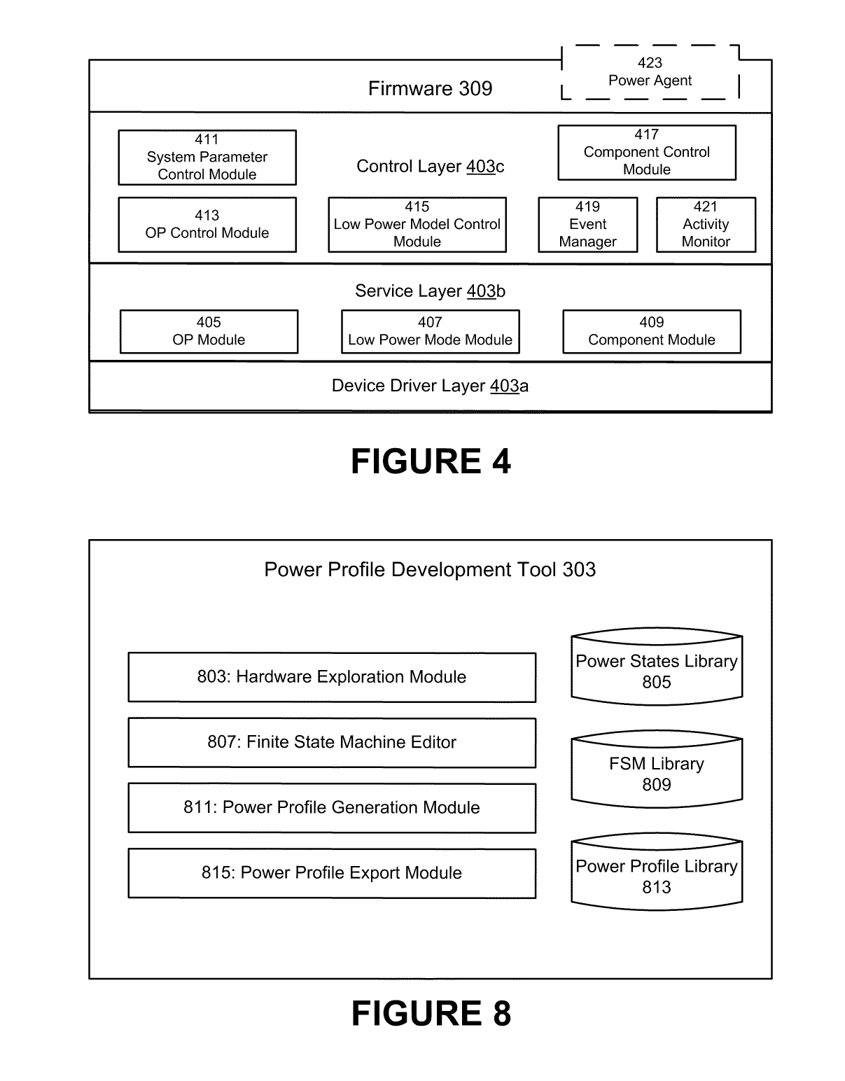

Various implementations of the present invention partition the firmware 309 into layers. FIG. 4 illustrates the firmware 309, having layers 403. As can be seen, the firmware 309 has a device driver layer 403a, a service layer 403b and a control layer 403c. The device driver layer 403a includes the various drivers needed to operate the hardware 307. More particularly, the device driver layer 403a includes software instructions that enable the various components of the hardware 307 to operate. The service layer 403b includes various modules that are configured to perform low-level monitoring and control of power consumption. The control layer 403c, conversely, is configured to perform high-level power control operations. More particularly, the control layer 403c includes modules that are configured to implement a power profile 123 (shown in FIG. 1.)

### Service Layer

With some implementations, the service layer 403b includes a processing unit operating point management module 405, a low power mode module 407, and a hardware component power module 409. The processing unit operating point management module 405 may be used to specify the operating point (i.e. the voltage, the frequency, or both) at which the computing unit (e.g. the computing unit 107 shown in FIG. 1) operates. Additionally, the module 405 may cause the computing unit to enter various low power modes, such as, for example, a sleep state, or an idle state. The module 405 may include various software instructions that can be executed and cause the computing unit to enter these various states, such as, for example, by exposing a timer tick suppression service, which would force the computing unit to enter a low power state.

The low power mode module 409 may be used to monitor and determine the power states that the embedded system 305 is in. Additionally, the low power module may be used to monitor power consumption of the various hardware components 307. The hardware component power module 403c may be used to control the power of various hardware components 305. For example, the module 403c may include software instructions that when executed cause the output device 109 to change power states.

### Control Layer

With various implementations, the control layer 403c includes a system parameter control module 411, a processing unit operating point control module 413, a low power mode control module 415, a hardware component control module 417, an event monitor 419, and an activity monitor 421. As stated, the control layer 403c is configured to perform high-level power management operations. More particularly, the various modules within the control layer 403c may be configured by the tool 303 based upon various high-level power management models. This will be discussed in greater detail below.

Some implementations of the invention represent these high-level power profiles as state transition diagrams or finite state machines (FSMs). Those of skill in the art will appreciate that a number of other representations exits, such as, for example a lookup table, which may be equally suitable. Although the balance of this disclosure uses finite state machines to illustrate the various implementations described herein, substitutions may be made for these particular representations without departing from the scope of the invention.

In various implementations, the system parameter control module 411 may be configured to account for various system use cases. More particularly, as those of skill in the art will appreciate, variables (herein referred to as “power management variables”) may be used to define the intended power usage for an embedded system based upon the usage of the embedded system. More specifically, variables may be used to represent when an embedded system or hardware component within the embedded system should transition from one power state to another. Examples of some power management variables that may be accounted for by the module 411 are the time during which the display stays in a particular power state, the processing unit utilizations thresholds that cause a change in the processing unit operating point, system latency corresponding to various operations, or a time before a communication is considered interrupted.

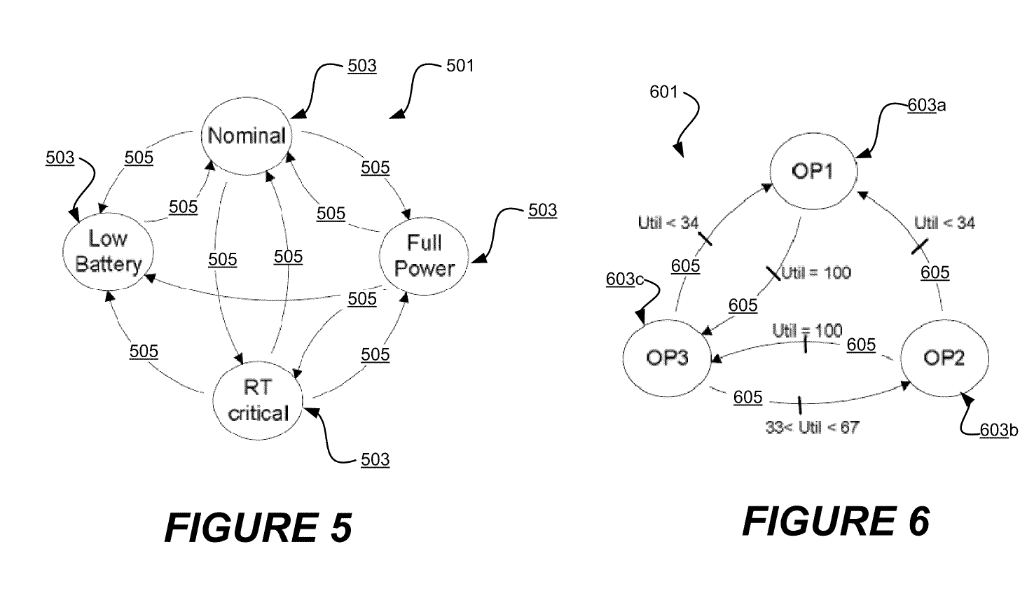

FIG. 5 illustrates a state transition diagram 501 that may be used to represent the various power states of the system. As can be seen from this figure, the diagram 501 includes states 503 and transitions 505 between the states 503. The different states 503 may have a number of different power management variables associated with each state. For example, the figure illustrates four (4) states 503a-503d. State 503a corresponds to a full power state, state 503b corresponds to a normal state, state 503c corresponds to a critical operation state and state 503d corresponds to a low battery state. In some implementations, it may be appropriate to have the critical operation state 503d correspond to the highest processing unit operating point. As such, when the system is in the critical operation state 503d, the processing unit in the embedded system will process instructions as the fastest speeds available.

As those of skill in the art will appreciate, the states 503 may differ depending upon the embedded system and the intended use of that embedded system. Furthermore, as indicated above, the control layer 403c modules, such as, for example, the system parameter control module 411 is configured by the power profile development tool 303. In addition to this, as will be discussed in greater detail below, the different high-level models describe herein, often represented in as finite state machines, may also be developed on the tool 303.

The operating point control module 413 may be configured to allow the processing units operating point to be dynamically adjusted. As those of skill in the art will appreciate, many processing units allow either or both of the clock frequency or supply voltage of the processing unit to be dynamically controlled during operation of the processing unit. This is often referred to as Dynamic Voltage Frequency Scaling (DVFS). FIG. 6 illustrates a state transition diagram 601 having states 603 and transitions 605. The states 603 may correspond to various processing unit operating points (Ops) and the transitions 605 may correspond to different utilization threshold values, as shown in FIG. 6. For example, the transition 605 from state 603a (i.e. operating point 1) to state 603c (i.e. operating point 3) corresponds to a processing unit utilization threshold of 100%.

As discussed above, some hardware within an embedded system will typically include various low power states. For example, many integrated circuits designed for embedded system use include low power states, such as, a “sleep” state and an “idle” state. Additionally, many modern integrated circuits include different levels of sleep or idle. The low power control module 415 may be configured to account for various low power states that the hardware within the embedded system can be placed into. The hardware component control module 417, in turn, can be configured to account for various different power states that the other hardware within the embedded system can be placed into. For example, some embedded systems include a global positioning system (GPS) radio, this radio may be switched on and off. Another example is an LCD display, which may be switched on or off as well as powered on at various states between off and full power.

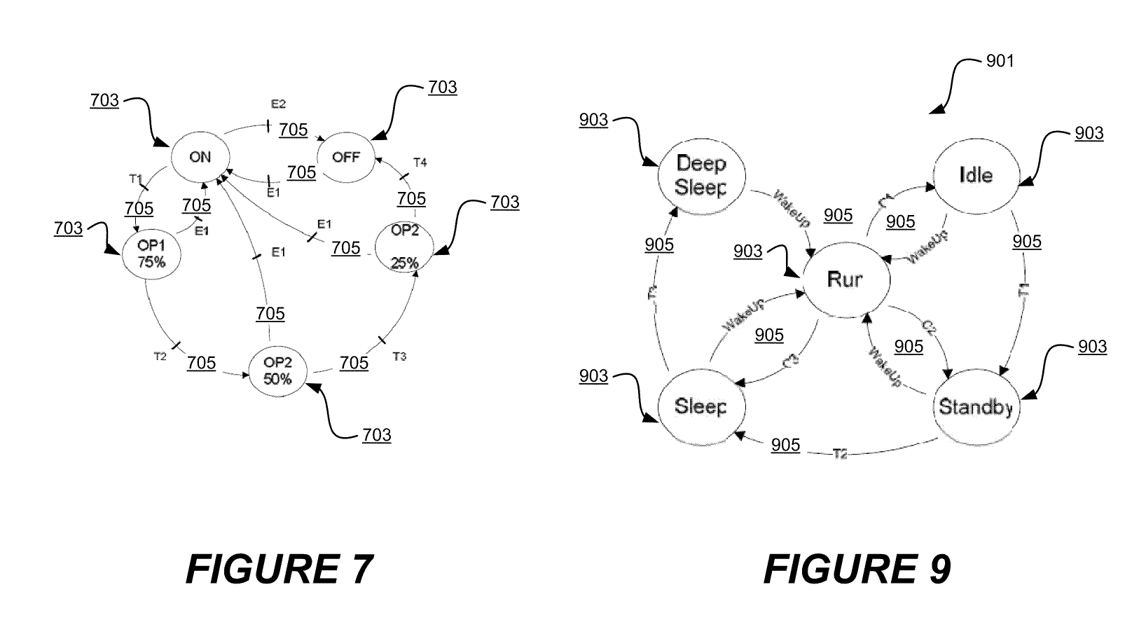

FIG. 7 illustrates a state transition diagram 701 that may be provided for an LCD display in an embedded system. As can be seen from this figure, the diagram 701 includes states 703 and transitions 705. The states 703 correspond to various power states, such as, for example, on, off, 25% brightness, etc. The transitions 705 correspond to different events and time-out periods.

As described above, the various modules within the control layer 403c include profiles that are driven by events. The event monitor 419 is configured to provide a centralized means for managing these events. In some implementations, the event monitor 419 may be configured to allow event posting by various hardware components within the embedded system. Furthermore, event posting may be allowed by software or applications executing on the embedded system. Additionally, hardware components within the embedded system may utilize the event monitor 419 to wait on a particular event. In further implementations, multiple components may be allowed to wait on a single event. In still further implementations, event waiting may be provided in an asynchronous manner.

The activity monitor 421 may be configured to detect hardware component activity levels. For example, a hardware component that is inactive or has a changing activity level may be detected and utilized in the overall power profile implemented by the control layer.

As detailed above, various finite state machines may be developed to represent the power states and power management variables controlling transitions between these states. Illustrative state transition diagrams have been shown that correspond to sample finite state machines. Those of skill in the art will appreciate, that the illustrated diagrams are not intended to be limiting and that the techniques of the present invention are equally applicable to an embedded system that has more, less, or different power state and power management variables than those shown.

### Host Development Tool

Returning to FIG. 3, as illustrated, the development system 301 includes the embedded system 305 described above as well as the host development tool 303. FIG. 8 illustrates a power profile development tool 303 that may be provided by various implementations of the present invention. As can be seen from this figure, the power profile development tool 303 includes a hardware exploration module 803, a power state library 805, a finite state machine editor 807, a finite state machine library 809, a power profile generation module 811, a power profile database 813, and a power profile export module 815.

As described in detail above, each embedded system includes a number of hardware components that influence the power profile for the embedded system. The hardware exploration module 803 in conjunction with the power state library 805 is used to define the different available power states and power management variables for the hardware 307 of the embedded system 305. The finite state machine editor 807 may then be used to develop finite state machines that represent intended power management behavior of the embedded system, which can be stored in the finite state machine library 809.

FIG. 9, illustrates a state transition diagram 901. As can be seen from this figure, the diagram 901 includes states 903 and transitions 905. As described previously, the states correspond to power states for a hardware component within the embedded system. The diagram 901 represents the power states for a processing unit within an embedded system. In various implementations, the power states and transitions can be defined using conventional programming languages, such as, for example, C++. The following example illustrates how the power states and transitions corresponding to FIG. 9 may be defined.

Static Data
Switching_Latency( )|Time to transition from < > to run mode
Threshold_Time ( )|Minimum time to Stay in < > mode

Variable Data
Max_Acceptable_Latency|Max acceptable time to transition from < > to run mode
Expected_Idle_Time|Time before expiration of earliest soft timer
Accumulated_Idle_Time|Incremented with the idle timer value, reset to zero is run mode is entered.

T1=
Idel_Time expirec &&
(CPU OP is lowest) &&
(Switching_Latency (Standby)<Max_Acceptable_Latency) &&
(Expected_Idle_Time infinite) &&
Accumulated_Idle_Time>Threshold_Time (Standby)

T2=
Idel_Time expirec &&
(CPU OP is lowest) &&
(Switching_Latency (Standby)<Max_Acceptable_Latency) &&
(Expected_Idle_Time infinite) &&
Accumulated_Idle_Time>Threshold_Time (Sleep)
(Required Wakeup Sources Available (Sleep))

T2=
Idel_Time expirec &&
(Expected_Idle_Time infinite) &&
Accumulated_Idle_Time>5 ms &&
(Required Wakeup Sources Available (Deep Sleep))

C1=
(Idle State Entered) &&
(Switching_Latency (Idle)<Max_Acceptable_Latency) &&
(Threshold_Time (Idle)<Expected_Idle_Time) &&

C2=
(Idle State Entered) &&
(All Power Management Components in Lower Power State) &&
(CPU OP is lowest) &&
(Switching_Latency (Standby)<Max_Acceptable_Latency) &&
(Threshold_Time (Idle)<Expected_Idle_Time) &&

C3=
(Idle State Entered) &&
(Expected_Idle_Time infinite) &&
(Required Wakeup Sources Available (Sleep))

As can be seen from this example, states and transitions can be defined using programming languages. These definitions can then be used to form a finite state machine to represent the desired power behavior. As stated, these finite state machines may be stored in the finite state machine library 809. The power profile generation module 811 may be used to combine a number of different finite state machines from the finite state machine library 809 into a power profile, which may then be stored in the power profile library 813. Subsequently, the power profile export module 815 may be used to export a power profile to the embedded system 305. More specifically, the module 815 may be used to configure the control layer 403c in the firmware 309 to implement a power profile.

### Power Profile Verification

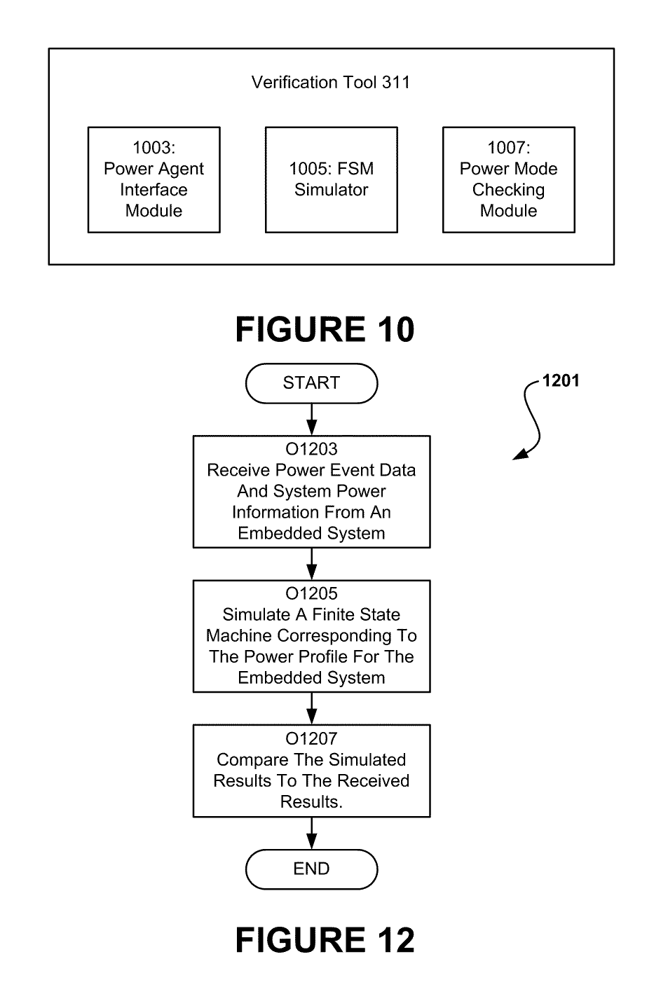

Returning to FIGS. 3 and 4, as can be seen, the power profile development tool 303 may optionally include a verification tool 311 and the firmware 309 may include a power agent 423. In various implementations, the power agent 423 is used in conjunction with the verification tool 311 to verify functionality of various power profiles or finite state machines from the power profile library 813 or the finite state machine library 809. FIG. 10 illustrates a verification tool 311 that may be provided by various implementations of the present invention. As can be seen from this figure, the verification tool 311 includes a power agent interface module 1003, a finite state machine simulator 1005, and a power mode checking module 1007. The power agent interface module 1003 communicates with the power agent 423 and receives real-time power event and system power status information from the embedded system 305. As stated above, in many implementations, the embedded system may be simulated. As such, the firmware 309 will be executing on a simulation of the embedded system hardware 307. As those of skill in the art will appreciate, other suitable methods exist for executing firmware 309, and as such, they will not be discussed herein. Furthermore, as those of skill in the art will appreciate, the term “real-time” may not necessarily mean instantaneous communication. What is meant by real-time is that during execution of the firmware, the power agent 423 may communicate various power events and system power status information to the verification tool 311. In alternative implementations, the power event data and system power status information may be recorded by the power agent 423 and later communicated to the verification tool 311 for use in a verification process as described below.

The finite state machine simulator 105 may be used to simulate a finite sate machine. In various implementations, a finite state machine corresponding to a desired power behavior may be simulated using the power events received from the power agent 423. Subsequently, the power mode checking module 1007 may be used to compare the simulated finite state machine results to the system power status results to determine if the control layer 403c is operating as expected.

### Power Profile Development and Verification Methods

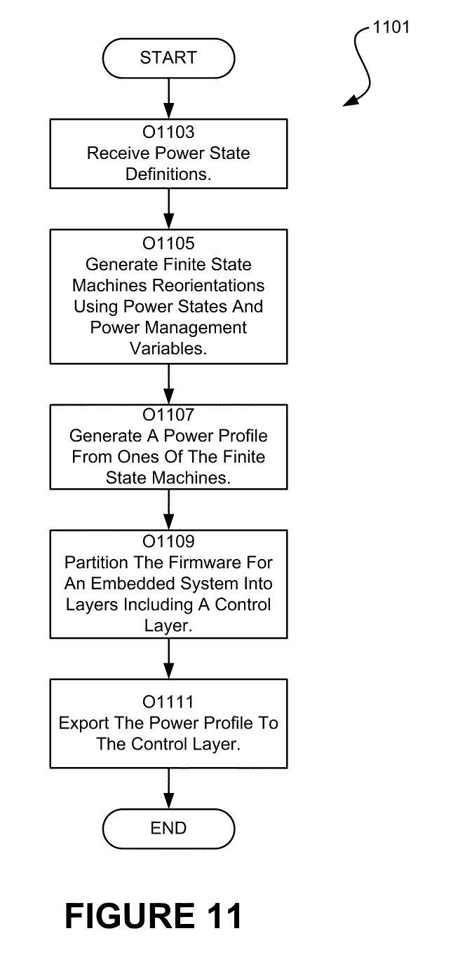

FIG. 11 illustrates a method 1101 that may be provided by various implementations of the present invention to develop a power profile for an embedded system. As can be seen from this figure, the method 1101 includes an operation 1103 for receiving power state definitions. Power states and different ways for defining a power state are detailed above. In some implementations the power states are defined by a user of the method 1101. In other implementations, the power states are predefined by the provider of the embedded system hardware. Subsequently, at operation 1105 two or more finite state machines may be generated to represent desired power management behavior using the received power states and power management variables. An operation 1107 is provided for generating a power profile 1107 from ones of the generated finites state machines. As described previously, a power profile describes the overall high-level power management behavior for an embedded system and includes a number of representations that described power behavior for particular sub-systems within the embedded system. Then at operation 1109, the firmware for an embedded system is partitioning into layers, including a control layer as described above. An operation 1111 is also provided for exporting the power profile to the control layer. More particularly, the various modules within the control layer may be configured according to the representations within the power profile.

FIG. 12 illustrates a method 1201 that may be provided by various implementations of the present invention to verify the power management of an embedded system. As can be seen from this figure, an operation 1203 for receiving power event data and system power information from an embedded system is provided. An operation 1205 is provided, for simulating a finite state machine representation of desired power behavior using the received power event data. Subsequently, at operation 1207, the simulated results may be compared to the received power status information to determine if the embedded system is operating as intended or expected.

### CONCLUSION

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

1. An apparatus for developing a power management profile for an embedded system, the apparatus comprising:
a hardware exploration module configured to define power states for an embedded system, the embedded system including:
a plurality of hardware components, the defined power states corresponding to available power states for ones of the hardware components;
a firmware having a plurality of layers, one of the layers being a control layer;
a power state library configured to store the defined power states;
a power management representation editor configured to define a representation for the desired power management behavior for ones of the hardware components based in part upon the defined power states and a plurality of power events;
a power management representation library configured to store the defined representations;
a power profile generation module configured to generate a power management profile for the embedded system from ones of the defined representations;
a power profile library configured to store the generated power profiles; and
a power profile export module configured to export a one of the generated power profiles to the control layer, wherein the control is then configured to implement the desired power management behavior defined by the one of the generated power profiles.

2. A computer-implemented method of generating a power profile for an embedded system comprising:
receiving a set of power state definitions that corresponds to an embedded system having a plurality of hardware components;
generating a plurality of representations for the set of power state definitions corresponding to ones of the plurality of hardware components;
generating a power profile for the embedded system based at least in part upon the plurality of finite state machines; and
saving the power profile to a computer-readable storage location.

3. The computer-implemented method recited in claim 2, further comprising configuring the embedded system to implement the power profile.

4. The computer-implemented method recited in claim 3, wherein the embedded system includes a firmware component and the method act for configuring the embedded system comprises:
partitioning the firmware into layers;
designating a one of the layers as the control layer; and
configuring the control layer to implement the power profile.

5. One or more computer-readable storage media having computer executable instructions stored thereon, the computer executable instructions configured to cause a computer to perform a set of operations, the set of operations comprising:
receiving a set of power state definitions that corresponds to an embedded system having a plurality of hardware components;
generating a plurality of representations for the set of power state definitions corresponding to ones of the plurality of hardware components;
generating a power profile for the embedded system based at least in part upon the plurality of finite state machines; and
saving the power profile to a computer-readable storage location.

6. The one or more computer-readable storage media recited in claims 5, the set of operations further comprising configuring the embedded system to implement the power profile.

7. The one or more computer-readable storage media recited in claim 6, wherein the embedded system includes a firmware component and the operations for configuring the embedded system comprises:
partitioning the firmware into layers;
designating a one of the layers as the control layer; and
configuring the control layer to implement the power profile.
